(19) United States
(12) Patent Application Publication
(10) Pub. No.: US 2026/0262628 A1
(43) Pub. Date: Sep. 10, 2026

(54) WIRELESS NETWORK-CONNECTED RODENT TRAP CONFIGURED TO PROVIDE REAL-TIME INFORMATION AND TRAP STATUS

(71) Applicant: Ashkan Kermanian, San Jose, CA (US)

(72) Inventor: Ashkan Kermanian, San Jose, CA (US)

(21) Appl. No.: 19/547,587

(22) Filed: Feb. 23, 2026

Related U.S. Application Data
(60) Provisional application No. 63/761,333, filed on Feb. 21, 2025.

(51) Int. Cl. A01M 23/26; A01M 23/24; A01M 23/38; H04W 4/38; H04W 64/00

(52) U.S. Cl. CPC A01M 23/26; A01M 23/245; A01M 23/38; H04W 4/38; H04W 64/00

(57) ABSTRACT

A rodent trapping system provides a user with status of trap deployment, trap occupancy, and monitors rodent activity to facilitate effective trap placement. A trap, a mobile device having a mobile device application, and a cloud platform are wirelessly connected to remotely communicate the efficacy of a rodent trap to a user.

### CROSS-REFERENCE TO RELATED APPLICATION(S)

This application claims the benefit of priority under 35 USC § 119 to prior-filed and co-pending provisional patent application Ser. No. 63/761,333, Filed Feb. 21, 2025, by Ashkan Kermanian, the complete contents of which is hereby incorporated herein by reference.

### BACKGROUND

### Technical Field

The present device relates to the field of mouse traps, and more particularly, to smart, wireless communicating rodent traps.

### Background

Currently existing mouse traps, rat traps, and the like (referred to as “rodent traps”) are effective at capturing rodents when properly baited and set up by a person (or consumer). However, once the trap is set up, there is no communication between the trap and the consumer. Thus, if the trap goes off and a rodent is trapped, the consumer would not know unless they routinely make visual inspections of the trap (which typically means going under the house, into the attic, in a boiler room, in a basement or cellar, or to some other difficult to reach location).

After a few days, some people simply forget about the traps they've set up. This is troubling since it may take longer than a few days to capture a rodent. Consequently, the trap could easily end up capturing and killing a rodent after the person forgets about it. After some time, the carcass may begin emitting a foul odor which, when discovered, inevitably leads to a messy and smelly clean-up. In the interim, the animal carcass could attract flies, other pests, or vermin, thereby creating a new problem for the homeowner or person setting the trap. One problem's solution ending up introducing a new problem—not a result any consumer wants when they set a rodent trap.

While current rodent traps are effective, there is nothing in particular about the existing traps that helps the consumer to remember to check the trap. Furthermore, many people do not want to be bothered by checking the status of the trap every day, especially if the trap is placed in a difficult to reach location.

Therefore, what is needed is a way to improve communication between rodent traps and the consumers who purchase and use them by harnessing wireless data communications and other digital technology in the rodent trap in order to get real-time information about the status of the rodent trap and/or to enable the person to remotely check the status of the trap whenever desired.

### SUMMARY

A novel wireless network-connected rodent trap is disclosed. In some embodiments, the wireless network-connected rodent trap is equipped with a wireless communications module, a camera, a location module, and a battery that powers the wireless communications module, the camera, and the location module. In some embodiments, a mobile app connects to the wireless communications module for a user to configure after the trap is setup. Then, during operation (after setup and configuration), the wireless network-connected rodent trap of some embodiments is configured to monitor status of the trap and provide real-time information about the trap status to connected devices. In some embodiments, the wireless network-connected rodent trap monitors trap status in a plurality of aspects including, without limitation, discharge status of the trap, visual path status to ensure the trap is placed correctly and is unobstructed in approximate or nearby location to the rodent's routine path, and location status that provides a pinpoint location of the trap and visually outputs a relative position of the trap with respect to the user checking the location. In some embodiments, the wireless network-connected rodent trap is a reusable trap capable of re-usage many times.

### BRIEF DESCRIPTION OF THE DRAWINGS

Further details of the present device are explained with the help of the attached drawings in which:

FIG. 1A-1B depict schematic diagrams of embodiments of the present device.

FIG. 2 depicts a side view of an embodiment of the present device.

FIGS. 3A-B depict an isometric view and a side view of an embodiment of the present device in a semi-open position.

FIGS. 3C-C depict an isometric view and a side view of an embodiment of the present device in a fully open position.

FIGS. 3E-F depict an isometric view and a side view of an embodiment of the present device in a closed position.

FIG. 4A depicts an isometric assembly view of an embodiment of the present device.

FIG. 4B depicts an isometric detail view of an electronic board component in the present device.

FIGS. 4C and 4D depict close up views of an electronic board component in the present device.

FIGS. 5A and 5B depict a flowchart of a method for using the present device.

FIG. 6 depicts a flow chart of an alternative method for using the present device.

FIG. 7 depicts a flow chart of an alternative method for using the present device.

FIG. 8 depicts a flow chart of a method for changing the jaws in the present device.

FIG. 9 depicts a relationship diagram of an embodiment of the present device.

FIG. 10 depicts an exploded view of the device.

### DETAILED DESCRIPTION

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

In the following detailed description of the invention, numerous details examples, and embodiments of the invention are described. However, it will be clear and apparent to one skilled in the art that the invention is not limited to the embodiments set forth and that the invention can be adapted for any of several applications.

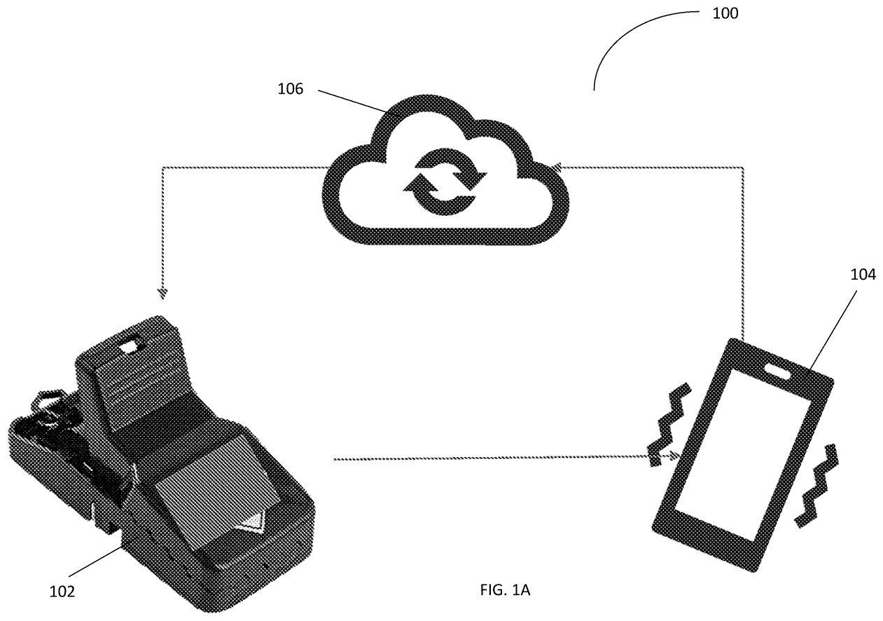

FIG. 1A-1B depict schematic diagrams of embodiments of the present system 100. A rodent trap 102 can be configured to monitor status of the trap and provide real-time information about the trap status to a connected device 104 running a mobile application operable by a user, or other electronic system via a cloud application service hosted by a cloud server (collectively referred to as the “cloud platform”) 106. Additionally, in some embodiments, the rodent trap 102 can comprise a camera 108.

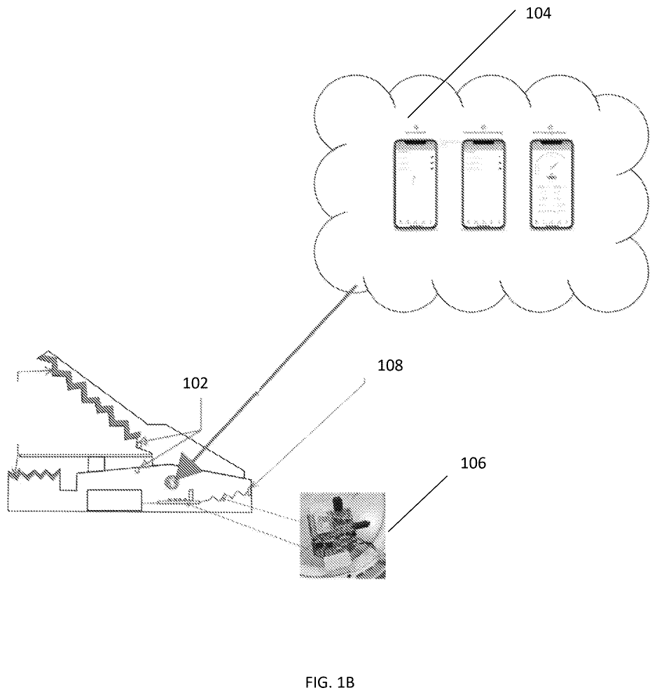

FIG. 2 depicts a side view of an embodiment of the present device. In some embodiments, a wireless network-connected rodent trap 102 can comprise a wireless communications module 202, a camera 204, a location module 206, and a battery 208 that can power the wireless communications module 202, camera 204, and location module 206. In some embodiments, rodent trap 102 can further comprise a deployment status sensor 210 to monitor whether a trap 102 has been deployed to capture a rodent and/or other electronic components such as the audible alarm system 216 and/or visual indicator light 218. In some embodiments, the wireless network-connected rodent trap 102 can monitor trap status in a plurality of aspects including, without limitation, deployment status of a trap 102, visual path status to ensure a trap 102 is placed correctly and is unobstructed, and location status that can provide a pinpoint location of a trap and visually output a relative position of the trap with respect to a user checking the location. An electronic board 212 can control a wireless communications module 202 (which can be short or long range, such as Bluetooth®), a camera 204, a location module 206, a battery 208, a deployment status sensor 210 and/or the electronic board 212. In some embodiments, the wireless network-connected rodent trap 102 can be a reusable trap capable of re-usage many times and can further comprise replaceable blades 214. In some embodiments, the wireless communications module 202, camera 204, location module 206, battery 208, deployment status sensor 210 and/or the electronic board 212 can be internal or partially internal to the rodent trap 102. However, in alternate embodiments, the wireless communications module 202, camera 204, location module 206, battery 208, deployment status sensor 210 and/or the electronic board 212 can be external or partially external to the rodent trap 102.

In some embodiments, the wireless network-connected rodent trap 102 can further comprise an audible alarm system 216. In some embodiments, the audible alarm system can comprise an audio speaker that can be configured to audibly output bip sounds, or any other known and/or convenient sound, when a rodent is captured by the trap 102 but remains alive as evidenced by motion of the trapped rodent and/or the trap 102 can provide an audible output (the same or different) if a rodent is trapped and deceased. The bip sounds can be audibly output on a periodic basis such as every few seconds, every few minutes and/or can be emitted at random intervals. The bip sounds or chirping or other high-pitched (or pitch) noises are output through the audible alarm system 216 comprising one or more or speakers 216 in a manner that enables or aids a user in determining and/or locating which trap has captured a rodent (living or deceased). To configure the audible alarm system 216, a user can interact with a mobile device or application 104 to set the trap in alarm mode. Additionally, in some embodiments, the device can comprise a visual indicator light 218 that can be triggered in the same manner as the audible alarm system.

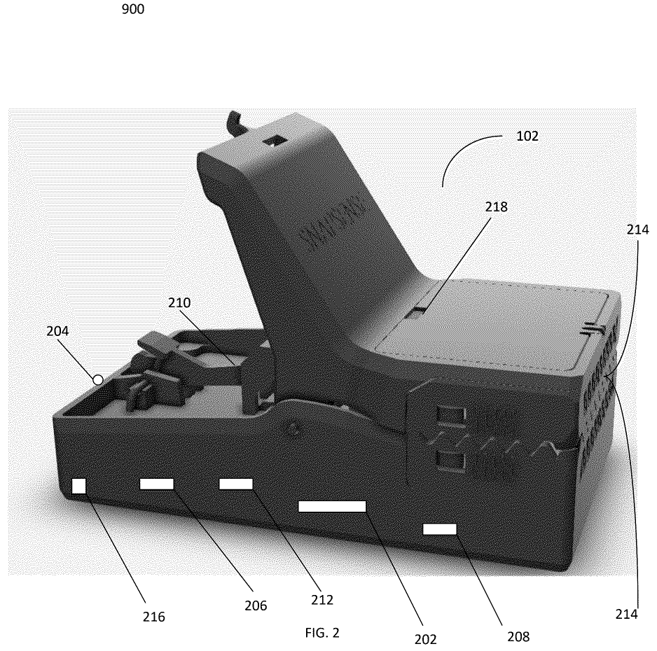

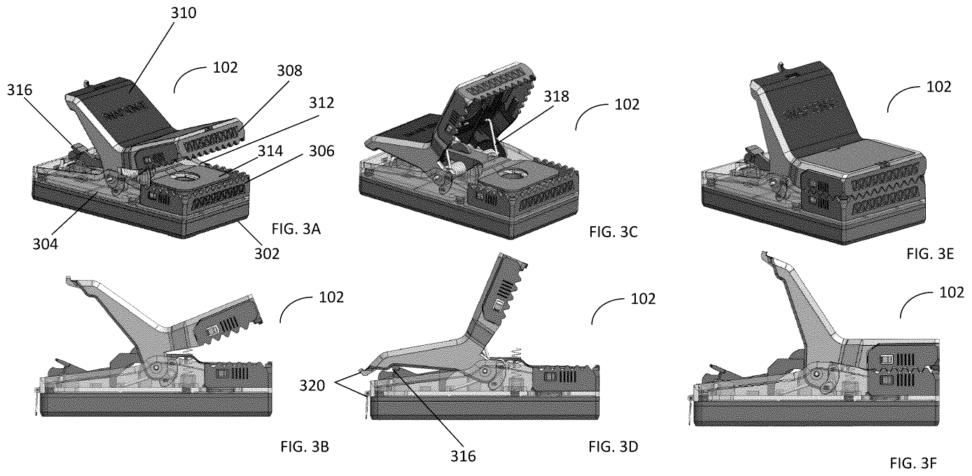

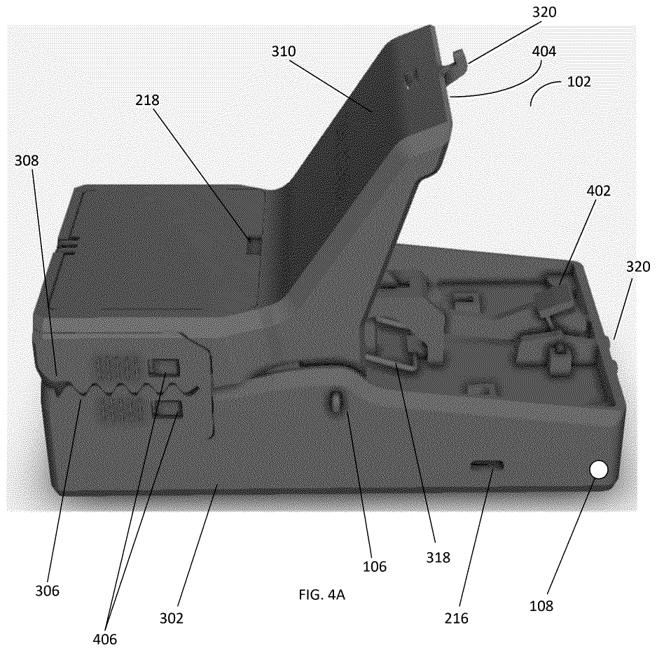

FIGS. 3A-B depict an isometric view and a side view of an embodiment of the present device in a semi-open position. In some embodiments, a trap 102 can comprise a base plate 302 and a mid-plate 304. A lower jaw 306 can protrude upward from a base plate 302 and a mid-plate 304. An upper jaw 308 can be integrated with and extend from a lever arm 310. An activation mechanism 312 can be positioned between a mid-plate 304 and an upper jaw 308 and lever arm 310 such that a pressure plate 314 (part of the activation mechanism 312) can be positioned between an upper jaw 308 and a lower jaw 306. In operation, the lever arm, can be pivoted around the activation mechanism 312 and biased in an open position by a biasing element 318 by temporarily securing the lever arm 310 to the activation mechanism 312. When the pressure plate 314 is actuated, anchor 316 coupled with the lever arm and the pressure place 314 can be released causing the upper jaw 308 to rapidly close on the lower jaw 306 with sufficient force to kill, maim and/or capture/secure a rodent. In some embodiments, the trap 102 can comprise a locking mechanism 320 to secure the trap 102 in an open position and inhibit the trap from closing. Further, in some embodiments, the upper jaw 308 and lower jaw 306 can be selectively removable and replaceable.

FIGS. 3C-D depict an isometric view and a side view of an embodiment of the present device in a fully open position.

FIGS. 3E-F depict an isometric view and a side view of an embodiment of the present device in a closed position.

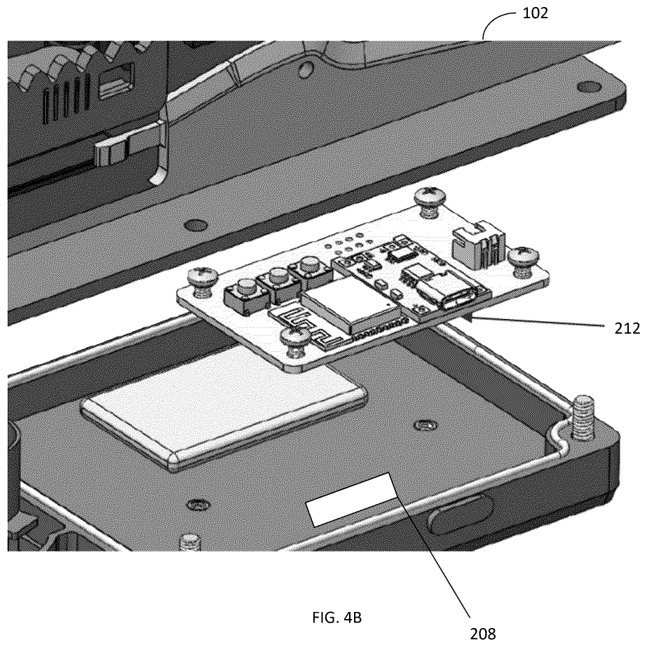

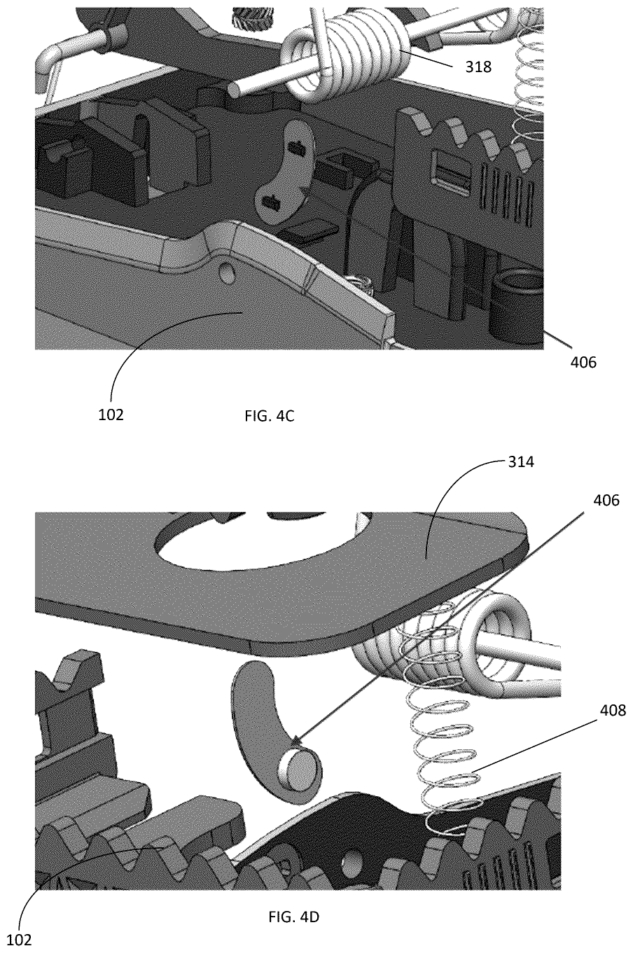

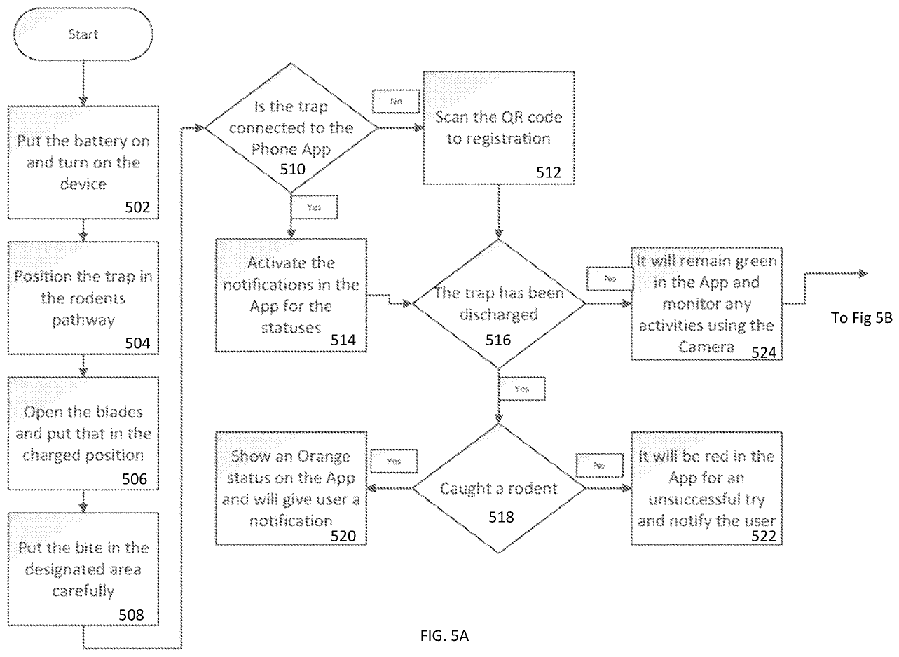

FIGS. 4A-D depict isometric assembly views of an embodiment of the present device 100. A base plate 302 can be vertically connected to a mid-plate 304 via screws, rivets, bolts, clips, or any other known and/or convenient fasteners. An activation mechanism 312 can further comprise a base member 402 directly above and connected to a mid-plate 304. A hook 404 can be pivotally connected to a base member 402 such that it latches to the bottom surface of the lever arm 310 of a top jaw 308, holding it in an open position. A biasing element 318 (such as a spring) can be connected to the end of a pressure plate 314 and the bottom surface of a lever arm 310 such that it can be compressed and held in position by a hook 404. When a pressure plate 314 is depressed, a hook 404 can be disengaged from a lever arm 310, causing the top jaw 308 to snap downward toward a lower jaw 306. As depicted in FIG. 4b an electronics board 212 can be internal to the trap 102 and can be coupled with the base 302 and/or mid-place 304 and the battery 208.Figures 4c and 4d depict a detailed view of an internal sensor adapted and/or configured to detect/determine whether a trap 102 is in an open or closed position. Additionally, FIG. 4D depicts an optional spring element positioned below the pressure plate 314 adapted an configured to bias the pressure plate 314 in an elevated position to reduce the likelihood of the trap 102 being accidently triggered.

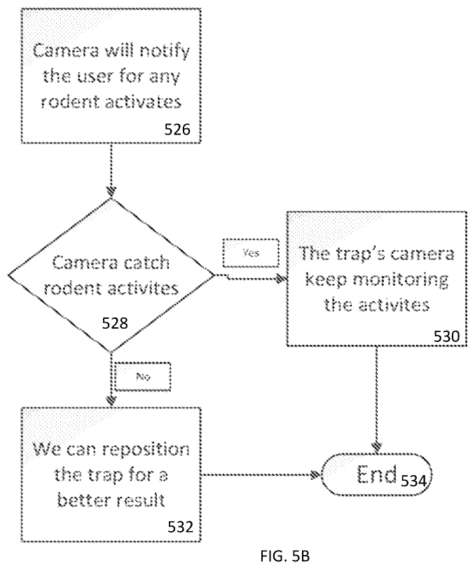

FIGS. 5A and 5B depict a method for using the present device. In some embodiments, a user can complete the following steps in any known and/or convenient manner:

As shown in FIGS. 5A-B, in step 502, a battery 208 can be placed into the trap 102 and turn the trap 102 can be turned on. Then in step 504, the trap 102 can be positioned in a rodent's pathway or in any known, convenient and/or desired location. In step, 506, the lower jaw 306 and an upper jaw 308 can be opened and secured in an open position with a hook 404 and in step 508 bait (of any desired form) can be placed on any known and/or convenient location on the pressure plate 314.

In step 510, it can be determined if a trap 102 is connected to a mobile device application 218 and if a trap 102 is not connected to a mobile device application 218, the trap 102 can be scanned via a provided QR code (or other know, convenient and/or desired identifier) to register the trap 102 within a mobile device application 218. If in step 510 it is determined that a trap 102 is connected to a mobile device application 218, then in step 514 notifications can be activated within a mobile device application 218 for status updates.

In step 516, the trap waits and determines if the trap 102 has been deployed. If a trap 102 has been deployed, then in step 518 the trap can determine if a rodent has been caught. In some embodiments, this can be accomplished via one or more sensors 406 and/or via the camera 204.

If a rodent has been caught, then in step 520 a mobile device application can display a visual color indicator, such as, but not limited to orange and give a user a notification. If a rodent has not been caught, then in step 522 a mobile device application can display a visual color indicator, such as, but not limited to red and give a user a notification of an unsuccessful capture. Additionally, if a trap 102 has not been deployed, then in step 524, a mobile device application 218 will indicate so via a visual color indication, such as, but not limited to green and monitor activities via a camera 204.

In step 526, camera 204, via a mobile device application 218 can notify a user of any rodent activities and the trap can determine if a camera has captured rodent activities in step 528, via pattern matching and/or other known convenient and/or desired identification techniques. If rodent activities have been captured, a camera 204 can continue monitoring activities in step 530. However, if rodent activities have not been captured, the trap 102 can be repositioned to enhance the likelihood of success. Then in step 534 the process can end and/or the process can be returned to step 516 to determine if the trap has been deployed.

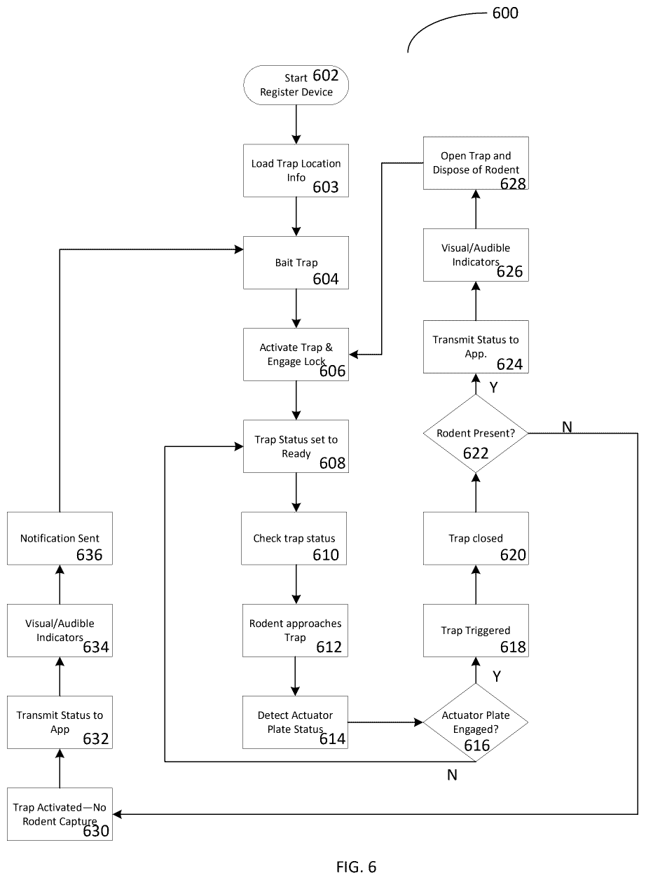

FIG. 6 depicts a flow chart 600 of an alternative method for using the present device. In some embodiments, a user can complete the following steps in any known and/or convenient manner:

In step 602 a trap can be registered to a mobile device then in step 603 the trap 102 can be loaded with location information and the trap can be baited in step 604. In step 606, the trap can be activated and the primary engagement mechanism can be engaged such that the trap can be triggered by actuation of the pressure plate 314 and the trap 102 status can be set to “ready” 608 within the application. In step 610 the status of the trap can be checked and it can be determined whether a rodent is approaching trap in step 612 via one or more sensors and/or the camera 108.

In step 614, the trap 102 can monitor the actuator plate 314 status. If in step 616 it is determined that the actuator plate 314 remains engaged 616, then the process can return to step 608. If in step 616 it is determined that the actuator plate has been activated, then the system can proceed to step 618 and set status to trap triggered. Then in step 620 the system will determine whether the jaws 306/308 of the trap 102 are completely closed. Based on the determination of whether the jaws 306/308 of the trap 102 are completely closed, the system can determine whether a rodent is present—completely closed jaws 306/308, indicate that the trap 102 has been activated, but no rodent is present, incomplete closure of jaws 306/308, indicate that the trap has been active and a rodent is likely present.

If in step 622 it is determined that a rodent is present, then a rodent captured status can be transmitted in step 624 from the trap 102 to the application 104 and the trap can begin to emit a visual and/or audible signal in step 626 and the trap can be opened and the rodent can be disposed of in step 628. Then the trap can be reset and the process can return to step 606.

If in step 622 it is determined that a rodent is not present, then it can be determined in step 630 that the trap was activated, but no rodent is present and in step 632, a corresponding status can be transmitted to the application 104. Additionally, visual and/or audible signals can be emitted from the trap 102 to facilitate location of the trap so that it can be reset and a notification of such can be transmitted in step 636 and the process can return to step 604.

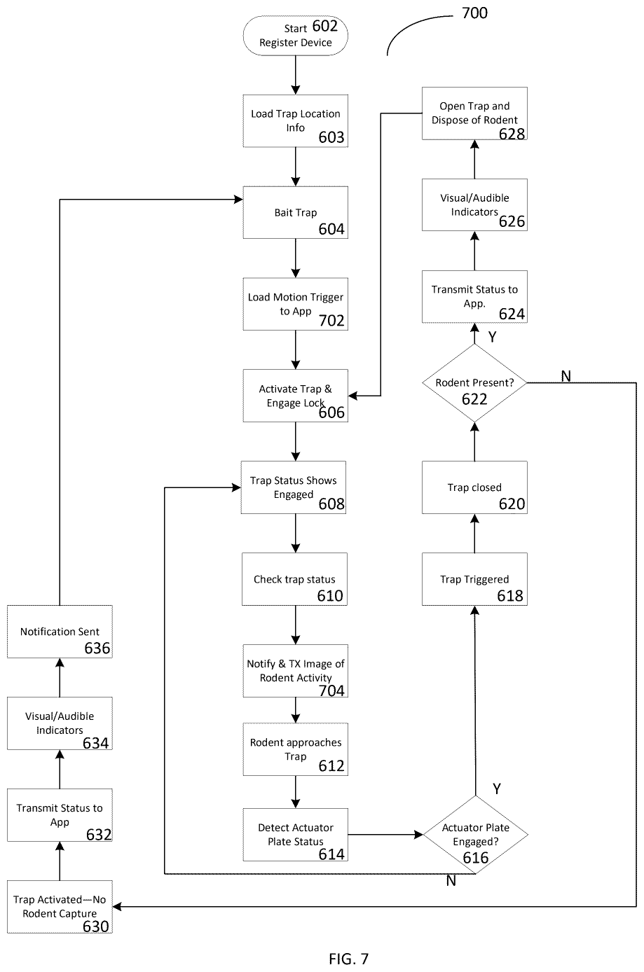

FIG. 7 depicts a flow chart of an alternative method for using the present device. In some embodiments, a user can complete the following steps in any known and/or convenient manner:

In step 602 a trap can be registered to a mobile device then in step 603 the trap 102 can be loaded with location information and the trap can be baited in step 604. Then in step 702, a motion trigger signal can be loaded to the application. In step 606, the trap can be activated and the primary engagement mechanism can be engaged such that the trap can be triggered by actuation of the pressure plate 314 and the trap 102 status can be set to “ready” 608 within the application. In step 610 the status of the trap can be checked and in step 704 notification of motion and/or an image of activity can be transmitted to the application. Thein in step 612 it can be determined whether a rodent is approaching trap 102 via one or more sensors and/or the camera 108.

In step 614, the trap 102 can monitor the actuator plate 314 status. If in step 616 it is determined that the actuator plate 314 remains engaged 616, then the process can return to step 608. If in step 616 it is determined that the actuator plate has been activated, then the system can proceed to step 618 and set status to trap triggered. Then in step 620 the system will determine whether the jaws 306/308 of the trap 102 are completely closed. Based on the determination of whether the jaws 306/308 of the trap 102 are completely closed, the system can determine whether a rodent is present—completely closed jaws 306/308, indicate that the trap 102 has been activated, but no rodent is present, incomplete closure of jaws 306/308, indicate that the trap has been active and a rodent is likely present.

If in step 622 it is determined that a rodent is present, then a rodent captured status can be transmitted in step 624 from the trap 102 to the application 104 and the trap can begin to emit a visual and/or audible signal in step 626 and the trap can be opened and the rodent can be disposed of in step 628. Then the trap can be reset and the process can return to step 606.

If in step 622 it is determined that a rodent is not present, then it can be determined in step 630 that the trap was activated, but no rodent is present and in step 632, a corresponding status can be transmitted to the application 104. Additionally, visual and/or audible signals can be emitted from the trap 102 to facilitate location of the trap so that it can be reset and a notification of such can be transmitted in step 636 and the process can return to step 604.

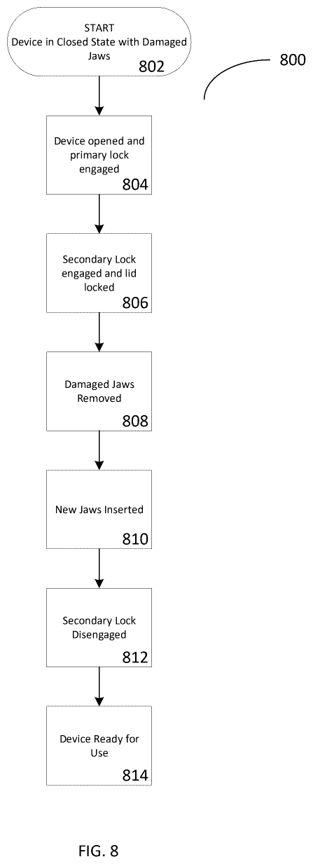

FIG. 8 depicts a flow chart of a method for changing the jaws 306 308 in the present device. In some embodiments, a user can complete the following steps in any known and/or convenient manner:

In step, 802, the process can start with a trap 102 in a closed state, but with damaged jaws 306 308. In step 804, the trap 102 can be opened and the activation mechanism 312 can be engaged, then in step 806 the secondary lock 320 can be engaged such that jaws 306 308 are locked open. In step 808, damaged jaws 306 308 can be removed and new jaws 306 308 can be installed in step 810. The secondary lock 320 can then be disengaged in step 812 and either the activation mechanism 312 can be disengaged and the trap 102 closed or the activation mechanism 312 can remain engaged and the trap 102 positioned, as ready for use.

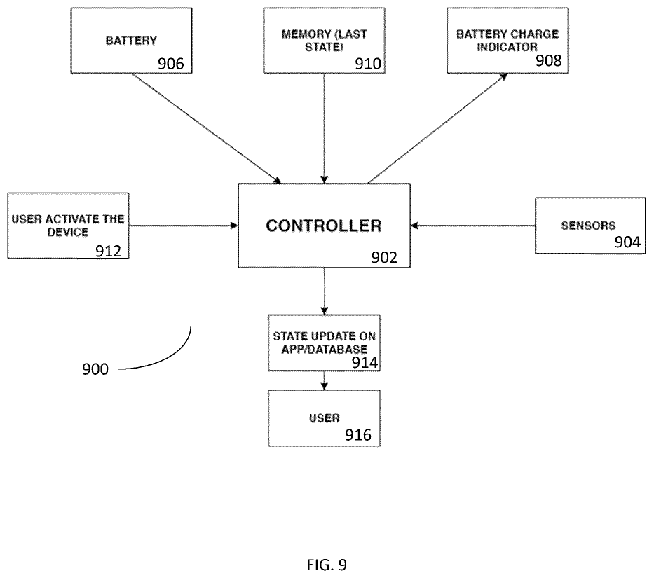

FIG. 9 is a relationship diagram 900 of an embodiment of the present device wherein all components of the device are in electrical communication. As shown in FIG. 9, a controller 902 is central to the system of the present device. Sensors 904 for deployment, location, rodent presence, and any other known and/or convenient status and user activation can provide input to a controller 902. A battery 906 and a memory component 910 storing status information can also provide input to a controller 902 after activation 912. A controller 902 can provide output information to a battery charge indicator 908, as well as status updates to on a mobile device application 104 and a database 914, which can then be provided to a user 916.

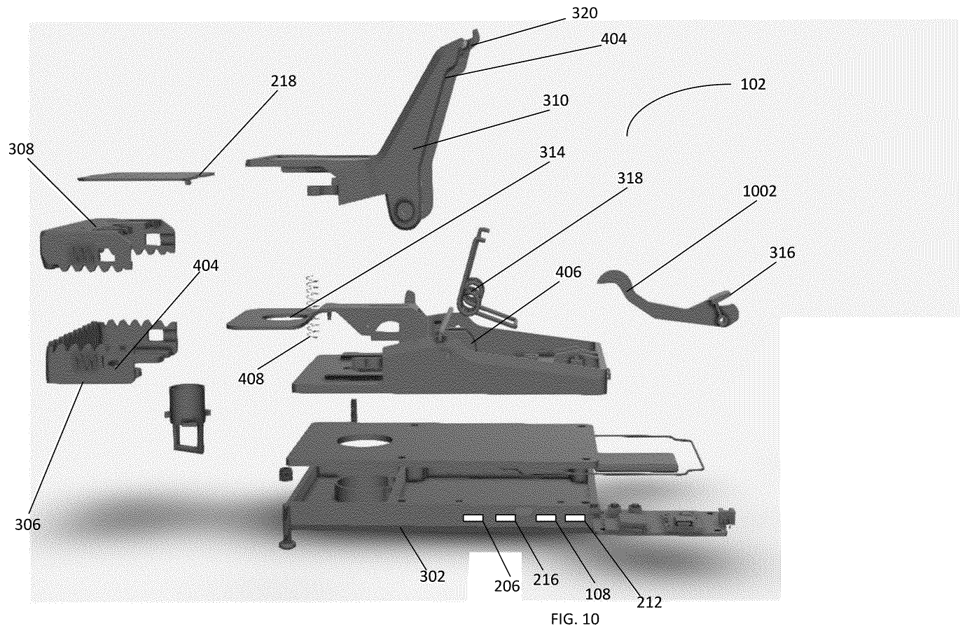

FIG. 10 depicts an exploded view of the trap 102 comprising wireless communication module 202, a camera 204, location module 206, battery 208, deployment status sensor 210, electronic board 212, replaceable blades 214, audible alarm system (speaker) 216 and visual indicator light 218 in addition to the lever arm 310, upper jaw 308, lower jaw 306, pressure plate 314 biasing element 318 and spring 408. Also depicted in the arm component 1002 of the activation mechanism 312 that is coupled with the anchor 316 that when actuated by the pressure plate 314 can release the upper jaw 308.

The various elements of the wireless network-connected rodent trap of the present disclosure as presented in the figures and in this Specification may be related in the following exemplary fashion. It is not intended to limit the scope or nature of the relationships between the various elements and the following examples are presented as illustrative examples only. The wireless network-connected rodent trap provides an innovative mousetrap with wireless connectivity (Bluetooth, WiFi, etc.) to communicate trap 102 discharge status and other information, as well as to provide real-time video feed content, to a companion mobile device application 218 installed on the user's mobile device (or alternately, to the cloud platform via WiFi/Internet). Example status information may include, without limitation, deployment status of trap 102, battery 208 charge status, location data, etc. The time and date can also be recorded and conveyed for deployed trap status with the event notification. A camera 204 feature on the wireless network-connected rodent trap 102 can also have a motion detection capability that can be used to capture video clips of rodents or other pest activity without trap activation, which can be stored in the camera and/or uploaded to a cloud server for remote access and playback. A trap 102 can be configured as a conventional spring-loaded mousetrap with a simple open and closed loop control. A trap 102 can be equipped with a switch to activate the notification feature when a trap 102 spring 318 is released, thereby providing the deployment status of a trap 102. A camera 204 can also be positioned on the wireless network-connected rodent trap 102 to show whether a rodent trap 102 caught a mouse (after a deployment status indicates the trap was triggered/released, but would not necessarily indicate that a rodent was actually caught). This information would be helpful for the user to decide when to service the trap to remove a dead animal or to re-bait a trap when a rodent eluded capture. In this way, the wireless network-connected rodent trap 102 can be a veritable smart mousetrap with wireless connectivity that provides trap status notifications and live video via the built-in wireless camera for path, trap, and surrounding area video, as well as video of any activity or events. In this way, a wireless network-connected rodent trap 102 can be an enhanced mousetrap that helps the user promptly remove a rodent carcass or a trapped (but not killed) rodent from their home to maintain a clean and healthy residence. A wireless network-connected rodent trap 102 can also help users re-bait traps timely or choose better placement locations based on the collected video feed information. A companion mobile device application 218 can monitor multiple traps, making it much easier to rid a home of rodents without having to check each trap multiple times per day physically.

A wireless network-connected rodent trap 102 of the present disclosure can generally function by providing color-coded status information for each of several states the trap may be in at any given time. For instance, an open gate (green status) is when a trap 102 is in charged (or “set”) and waiting for a rodent. Once the trap goes off (discharges/deploys), if the front blades 214 on jaws 306 308 touch each other, a metal piece connected to each blade 214 can activate the second gate, putting the trap into closed status (red color) , meaning a trap 102 is deployed without securing a rodent. If a trap 102 is deployed but the two metal bits in blades 214 do not touch, that means there is something trapped in it and must be the reason those two front metal parts are not connecting while a trap 102 is discharged. This will put the trap in the success gate (orange color), which means a trap 102 must be looked at for possibly a dead rodent body.

To use the wireless network-connected rodent trap 102 of the present disclosure, a user can typically find a location to set up the wireless network-connected rodent trap 102 at an approximate location the user believes the rodent travels. The user can orient the camera along the approximate path to obtain more pinpoint information of whether or not the rodent routinely travels this path. Adjustments to the location can then be made manually by the user as needed. Once the position is set, the use can set the trap and bait it. The user can also download the mobile device application and install on a mobile device 104. The user can pair a mobile device 104 with a wireless network-connected rodent trap 102 via Bluetooth or any other known and/or convenient system. Alternatively, the user can connect to a cloud platform 106 and use a mobile device application to configure a wireless network-connected rodent trap 102 to use WiFi to connect to a local wireless router and, through the Internet, to a cloud platform 106. In this way, the user can check the status of the wireless network-connected rodent trap from any location, even when out of range for Bluetooth to work. In this way, the user can be able to monitor, catch, and remove rodents from a home or other building in the least amount of time to ensure health and cleanliness in the environment. Furthermore, the user can reuse the wireless network-connected rodent trap 102 if and when rodents are captured.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details but rather is to be defined by the appended claims.

Although exemplary embodiments of the invention have been described in detail and in language specific to structural features and/or methodological acts above, it is to be understood that those skilled in the art will readily appreciate that many additional modifications are possible in the exemplary embodiments without materially departing from the novel teachings and advantages of the invention. Moreover, it is to be understood that the subject matter defined in the appended claims is not necessarily limited to the specific features or acts described above. Accordingly, these and all such modifications are intended to be included within the scope of this invention construed in breadth and scope in accordance with the appended claims.

What is claimed:

1. A wireless network-connected rodent trap device comprising:
a trap, further comprising a set of jaws connected to a base plate and pressure plate, wherein the jaws are set to an open configuration and held in said open state by a hook connected to said pressure plate, such that movement on said pressure plate moves said hook to release said jaws into a closed position;
a electronics board electronically connecting
a location module,
a camera,
a deployment status sensor to detect trap deployment occupancy,
an occupancy sensor to detect the presence of a body in the trap,
a location sensor,
an audio device,
a battery;
a mobile device having a mobile device application;
and a cloud platform,
such that said trap, mobile device, and cloud platform are wirelessly connected.

2. The rodent trap device of claim 1, wherein said trap further comprises a mid-plate positioned between said base plate and said pressure plate;
wherein said jaws further comprise a lower jaw protruding upward from said base plate and said mid-plate and an upper jaw integrated with and extending from a lever arm pivotally connected to said base plate;
an activation mechanism positioned between said mid-plate and said upper jaw and said lever arm such that said pressure plate is positioned between said upper jaw and said lower jaw.

3. The rodent trap device of clam 2, wherein said upper jaw is connected to said base plate via a spring member such that said spring member stores potential energy when said upper jaw is in an open position and said activation mechanism transfers force applied to said pressure plate to release said hook.

4. The rodent trap device of claim 1, wherein said wireless communications module collects and transmits signals from said sensors to said mobile device.

5. A method for using the rodent trap of claim 1, comprising the steps of:
putting a battery into said trap and turning trap on;
positioning said trap in a rodent's pathway;
opening said lower jaw and said upper jaw and securing in an open position with said hook;
placing bait on said pressure plate;
determining if a said trap is connected to said mobile device application;
if said trap is not connected to said mobile device application, scan a provided QR code to register said mobile device application;
if said trap is connected to said mobile device application, activate notifications in said mobile device application for statuses;
determining if said trap has been deployed;
if said trap has been deployed, determine if a rodent has been caught;
if a rodent has been caught, said mobile device application displays a visual color indicator to give a user a notification;
if a rodent has not been caught, said mobile device application displays a visual color indicator and notifies a user of an unsuccessful capture;
if said trap has not been deployed, said mobile device application indicates such via a visual color indication and monitors activities via said camera;
said camera, via said mobile device application notifies user of any rodent activities;
determining if said camera has captured rodent activities;
if rodent activities have been captured, said camera continues monitoring said activities;
if rodent activities have not been captured, a user repositions said trap for a better result;
end the process.

6. A method for using the rodent trap of claim 1, comprising the steps of:
Registering said mobile device;
loading trap location information;
baiting said trap;
activating said trap and engaging said hook;
setting said trap status to “ready”;
checking said trap status;
rodent approaches said trap;
said actuator plate status detected;
determining if said actuator plate is engaged;
if said actuator plate is engaged, said trap is triggered;
said trap is closed;
determining if a rodent is present in said trap;
if a rodent is present in said trap, this status transmits to said mobile device application;
said mobile device application displays/emits visual and/or audible indicators;
user opens said trap and disposes of said rodent;
user resets and activates said trap;
if a rodent is not present, then said trap has been activated, but no rodent has been captured;
said trap transmits status to said mobile device application;
said mobile device application displays/emits visual and/or audible indicators;
said mobile device application sends user a notification;
bait trap
if no, reset and activate trap.

7. The method of claim 6, further comprising the steps of:
loading a motion trigger to said mobile device application;
transferring images of rodent activity.

8. A method for changing said jaws of the device of claim 1, comprising the steps of:
starting with a said trap in a closed state, but with damaged jaws;
opening said trap and engaging a primary lock;
engaging a secondary lock to lock open said jaws;
removing said damaged jaws;
inserting new jaws;
disengaging said secondary lock.

9. The rodent trapping device of claim 1, further comprising:
a controller;
wherein said controller receives input from sensors for deployment, location, and rodent presence, user activation, said battery, and a memory component,
wherein said memory component stores status information;
wherein said controller provides output information to a battery charge indicator, status updates on said mobile device application, and a database and sends said information to a user via said mobile device.
